(19) United States
(12) Patent Application Publication
(10) Pub. No.: US 2021/0178688 A1
(43) Pub. Date: Jun. 17, 2021

(54) THREE-DIMENSIONAL PRINTER WITH PNEUMATIC CONVEYANCE

(71) Applicant: HEWLETT-PACKARD DEVELOPMENT COMPANY, L.P., Spring, TX (US)

(72) Inventors: David R. OTIS, Jr., Corvallis, OR (US); Kevin E. SWIER, Corvallis, OR (US); Jeffrey L. THIELMAN, Sant Cugat del Valles (ES)

(73) Assignee: HEWLETT-PACKARD DEVELOPMENT COMPANY, L.P., Houston, TX (US)

(21) Appl. No.: 16/076,222

(22) PCT Filed: Jul. 28, 2017
(86) PCT No.: PCT/US2017/044308

§ 371 Date: Aug. 7, 2018

(51) Int. Cl. B29C 64/321; B29C 64/357; B65G 53/60

(52) U.S. Cl. CPC B29C 64/321; B33Y 40/00; B65G 53/60; B29C 64/357

(57) ABSTRACT

A three-dimensional (3D) printer and method having a pneumatic conveyance system (PCS) to transport build material to a vessel of the 3D printer. A feeder coupled to the vessel regulates the discharge flow of build material from the vessel. A sealing control coupled to the feeder reduces air inflow.

### BACKGROUND

Additive manufacturing (AM) may include three-dimensional (3D) printing to generate 3D objects. In some AM processes, successive layers of material are formed under computer control to fabricate the object. The material may be powder, or powder-like materials, including metal, plastic, ceramic, composite material, and other powders. The objects can be various shapes and geometries, and produced via a model such as a 3D model or other electronic data source. The fabrication may involve laser melting, laser sintering, electron beam melting, thermal fusion, and so on. The model and automated control may facilitate the layered manufacturing and additive fabrication. As for applications, AM may fabricate intermediate and end-use products, as well as prototypes, for aerospace (e.g., aircraft), machine parts, medical devices (e.g., implants), automobile parts, fashion products, structural and conductive metals, ceramics, conductive adhesives, semiconductor devices, and other applications.

### BRIEF DESCRIPTION OF THE DRAWINGS

Certain examples are described in the following detailed description and in reference to the drawings, in which:

FIGS. 1A-C are diagrams of three respective implementations of a 3D printer in accordance with examples;

FIG. 2 is an illustration of the pneumatic conveyance system of the 3D printer of FIG. 1C in accordance with examples;

FIG. 3 is an illustration of the centrifugal separator and vessel used in the 3D printer of FIG. 1C in accordance with examples;

FIG. 4 is an illustration of two types of air leakage that are overcome by the 3D printer of FIG. 1C in accordance with examples;

FIG. 5 is an illustration of the feeder of the 3D printer of FIGS. 1A-C in accordance with examples;

FIG. 6 is an illustration of the feeder used in the 3D printer of FIG. 1C in accordance with examples;

FIG. 7 is a flow diagram of the sealing control mechanism used by the 3D printer of FIGS. 1A-C in accordance with examples; and

FIG. 8 is a detailed block diagram of the 3D printer of FIG. 1C in accordance with examples.

### DETAILED DESCRIPTION OF SPECIFIC EXAMPLES

The techniques illustrated herein are directed to a three-dimensional (3D) printer having a pneumatic conveyance system (PCS) to transport build material, such as powder, enabling a 3D object to be generated. A feeder inside the 3D printer dispenses build material below the feeder. A chamber within the feeder is operated using a sealing control mechanism to control air upflow and downflow. In other words, as discussed below, the feeder has chambers that reduce air upflow from the feeder and air downflow from the feeder. This sealing control may provide that air upflow from the feeder does not cause the powder to become too aerated and agitated, which could impede powder downflow. The sealing control also substantially prevents air leakage (into the feeder) as upward airflow driven by a pressure gradient contrary to powder flow. The sealing control thus enables the feeder to isolate the pressure upstream of the feeder from that downstream of the feeder. This facilitates the 3D printer to contemporaneously transport build material and initiate a 3D print job to generate the 3D object for at least the reason that air upflow does not significantly interfere with powder flow or operation of a centrifugal separator disposed above the vessel. Moreover, because the conveyance of build material occurs during the print job, the cycle time to complete a 3D print job in the novel 3D printer is thus reduced, relative to those in which conveyance of build material is completed prior to generating the 3D object.

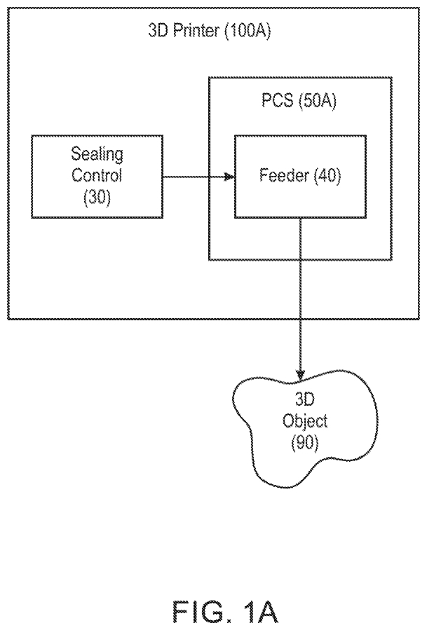

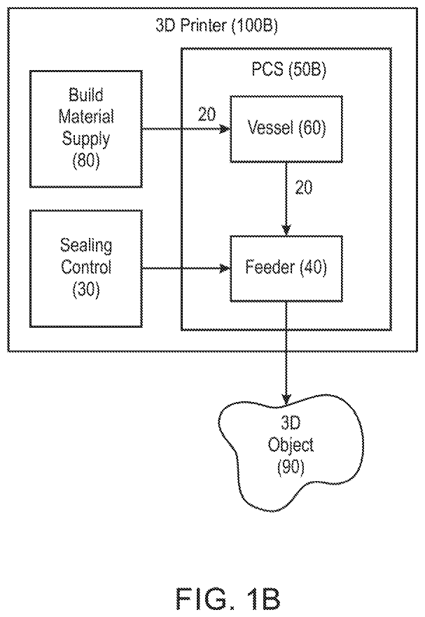

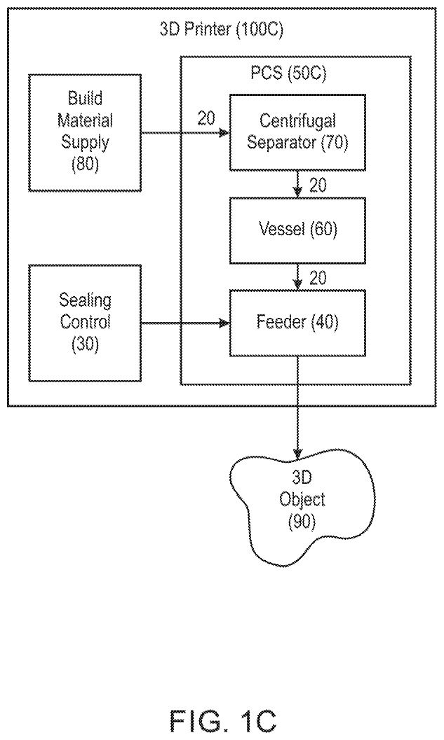

FIGS. 1A, 1B, and 1C are examples of a 3D printer 100A, 100B, and 100C, respectively, that may form a 3D object from build material such as on a build platform. Referring first to FIG. 1A, the 3D printer 100A includes a pneumatic conveyance system (PCS) 50A for transporting build material (e.g., powder) 20 to generate a 3D object 90. The PCS 50A includes a feeder 40, for dispensing the build material 20. The 3D printer 100A also includes a sealing control mechanism 30 for operating the feeder. The sealing control method 30 includes a DC motor and an encoder, as discussed in more detail, below.

FIGS. 1B and 1C present further examples of the 3D printer 100, indicated as 100B and 100C, respectively (collectively, “3D printer 100” or “3D printers 100”), and having PCS 50B and 50C, respectively (collectively, “PCS 50” or “PCSs 50”). In FIG. 1B, 3D printer 100E includes PCS 50B and sealing control mechanism 30, but further includes a build material supply 80 for dispensing build material 20 to the PCS 50B. The PCS 50B includes a vessel 60 disposed above the feeder 40 for receiving build material 20, such as powder, from the build material supply 80. In the 3D printer 100C, the build material 20 is fed into a centrifugal separator 70, then the vessel 60, before being received into the feeder 40. Coupled with the vessel 60, the centrifugal separator 70, known also as a powder trap or cyclone, separates the build material 20 from the conveying air more efficiently.

The 3D printing performed by the 3D printers 100 may include selective layer sintering (SLS), selective heat sintering (SHS), electron beam melting (EBM), thermal fusion, or other 3D printing and AM technologies to generate the 3D object from the build material. The build material may be powder, powder-like, or in powder form. The build material may be different materials including polymers, plastics, metals, ceramics, and so on. In operation, the 3D printer 100 employs additive manufacturing of the build material 20 to generate the 3D object 90.

The sealing control mechanism 30 is illustrated as being outside the PCS 50. However, the sealing control 30 may be part of the PCS 50 and with sealing control 30 elements as components of the feeder 40. As described in more detail below, in conjunction with the sealing control mechanism 30, the feeder 40 disallows air leakage driven by a pressure gradient contrary to powder flow. Further, during operation of the 3D printer 100, there is a first pressure upstream of the feeder (upstream pressure) and a different pressure downstream of the feeder (downstream pressure), where upstream and downstream refer to the flow of build material 20 in the PCS. As illustrated in more detail herein, the sealing control 30 helps the feeder 40 to isolate the upstream pressure from the downstream pressure. This enables the conveyance of build material 20 within the 3D printer 100 to take place as the 3D object 90 is being printed.

Pneumatic conveyance is a mechanism by which particles, in this case, build material, are suspended in conveying air. The particles are obtained from one or more source locations, transported via conduits (e.g., piping, tubing, etc.), and received at one or more destination locations. Pneumatic conveyance may convey air using positive pressure or negative gage pressure. Dilute phase pneumatic conveyance is generally characterized as being a relatively high-speed with a low ratio of build material (powder) to gas (air) (e.g., a powder to air mass ratio of less than 15). Dense phase pneumatic conveyance involves a low volume of gas at high pressure (positive pressure) or at high vacuum (negative pressure), with the ratio of conveying material to the gas being relatively high. In one implementation, the PCS 50 employs negative (vacuum) pressure to transport build material 20 through the 3D printer 100. In a second implementation, the PCS 50 employs negative pressure and dilute phase transmission to transport the build material 20. In one example, the typical airflow rate through the PCS 50 is around 6-8 cubic feet per minute of air. This corresponds to air velocities of between 15 and 19 m/sec in a ⅝″ inside diameter tube. In another example, when moving the build material or powder, the ratio of powder mass to air mass is less than 2, which allows movement of the powder through the conduits 66 at up to 5 g/sec.

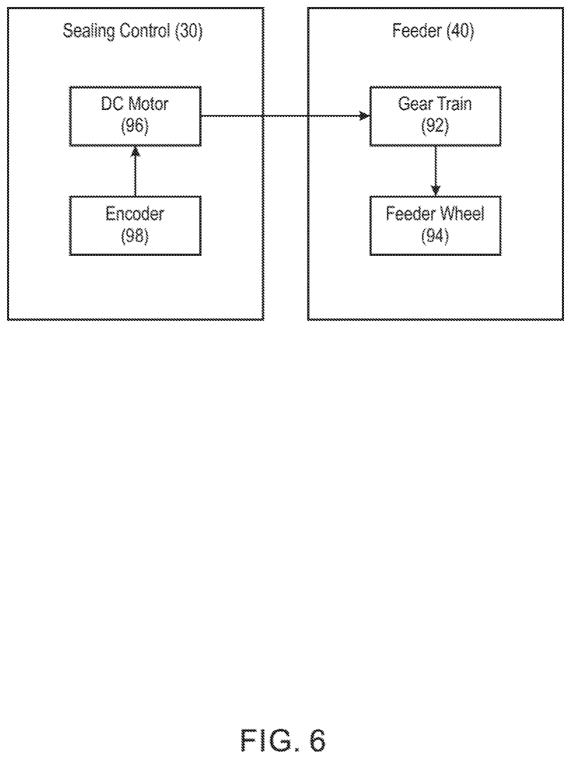

The feeder 40 of the 3D printer 100 receives the build material 20 from the PCS 50 and dispenses the build material such that the 3D object 90 may be generated. The feeder 40 is described in more detail in conjunction with FIG. 6, below.

The PCS 50 of the 3D printer 100 receives the build material 20 from the build material supply 80. The build material supply 80 may be a vessel such as a hopper, a bin, or a cartridge. In one example, the build material supply 80 is a removable cartridge. This provides for the build material supply 80 to be removed from the 3D printer when empty and replaced with a second (full) cartridge. In another example, the build material supply 80 includes reclaimed (or recycled) build material from a prior 3D print job. In another example, the build material supply 80 includes new build material combined with reclaimed (and/or recycled) build material. In yet another example, the build material supply 80 has a volume that is less than the volume needed to generate the 3D object 90.

In the 3D printer 100, the build material 20 conveyed by the PCS 50 is fed into the centrifugal separator 70, then the vessel 60, before being received into the feeder 40. The centrifugal separator 70, known also as a powder trap or cyclone, is designed to separate the build material 20 from the conveying air more efficiently. As with the build material supply 80, the vessel 60 may be a hopper, a bin, or a cartridge. The vessel 60 may have a conical or rectangular cross-section, with sloped walls, so that powder flows through it without adhering to the walls, and the build material 20 separates from the conveying air using gravity.

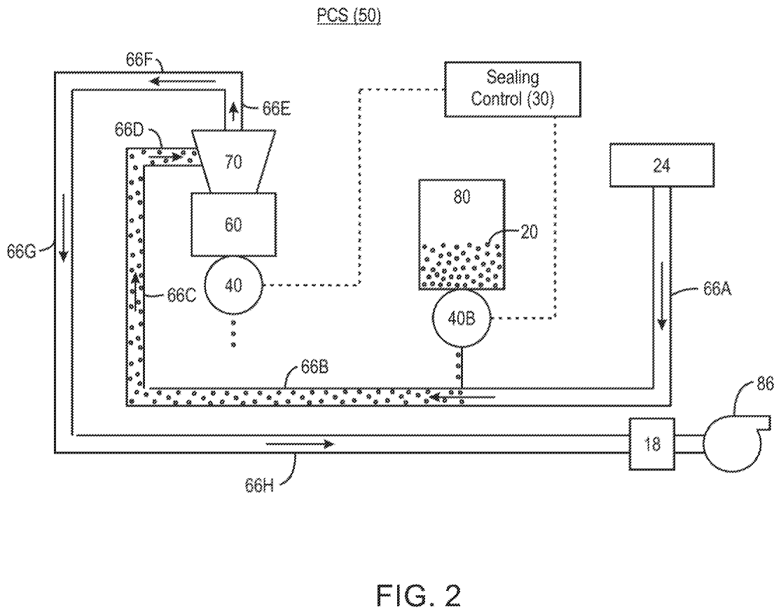

FIG. 2 illustrates the PCS 50 in more detail. The PCS 50 is made up of conduits 66A-H (collectively, “conduits 66”) (e.g., tubes, pipes, lines), the centrifugal separator 70, the vessel 60, the feeder 40, an air intake or lung 24, a filter 18, and a blower 86. A driving force behind the PCS 50 is the blower 86 that provides motive force for the air disposed inside the conduits 66. Indeed, once the blower 86 is operational, air at a negative pressure of air flows inside the conduits 66, conveying build material 20 to flow along the connected conduits in the direction shown by the arrows. Respective conduits making up the PCS 50 may meet or couple, such as via conduit tees or other fittings. In an example, the conduits 66 are disposed within the housing of the 3D printer 100.

The conduits 66 of the PCS 50 are fed build material 20 from the build material supply 80, by way of a second feeder 40B. The sealing control mechanism 30 controls both the feeder 40 and the feeder 40B. The feeder 40B controls the mass of powder relative to the mass of air in the conduit 66B, and thus helps to maintain the mass within certain limits. The build material 20 is dispensed via the feeder 40B to the conduit portion 668, where it is conveyed via air at negative pressure toward the centrifugal separator or cyclone 70, in this case, via conduits 66B, 66C, and 66D. Arrows in FIG. 2 indicate the direction of air flow. At the cyclone 70, the air is separated from the build material 20 and the air is pulled by negative pressure through conduits 66E, 66F, 66G, and 66H.

In one implementation, the PCS 50 is a negative pressure system. Air flow in the PCS 50 is established by the blower 86, located at the downstream end of the pneumatic line, setting up a negative pressure through the pneumatic line. When the blower 86 is activated, a negative pressure is created in the PCS 50, such that air from the air intake (lung) 24 flows through conduit 66A, conduit 66B (which also has build material 20), conduit 660, and conduit 66D, where the build material is received into the centrifugal separator 70. There, the build material 20 is separated from the air before being received into the vessel 60 that discharges the build material 20 through feeder 40. In the centrifugal separator 70, the separated air flows upward into conduit 66E, conduit 66F, conduit 66G, and conduit 66H, pulled by the negative pressure in the PCS 50. The air may be filtered before leaving the 3D printer 100 in some examples.

In one example, the blower 86 generates an airflow which gives velocities sufficient to convey the build material 20. Negative pressures through the PCS 50 provide that, if leaks happen, the build material 20 leaks inside the 3D printer 100, so build material is not leaked from the printer. In one implementation, an airflow rate of build material of up to 5 grams/second (g/sec) can be maintained in the PCS 50.

The PCS 50 can thus be characterized as having at least two general conduit sections, an input conveyance (conduits 66A, 66B, 66C, and 66D) and an output conveyance (conduits 66E, 66F, 66G, and 66H). The output conveyance, which should be air free or substantially free of build material 20, may not actually leave the PCS 50 or the printer 100, but may be used, for example, to fill the air intake 24 for subsequent operations. Where build material does leak into the output conveyance, the filter 18 disposed along the output conveyance may catch any stray particles.

The PCS 50, made up of the conduits 66, the air intake 24, the blower 86, the filter 18, the cyclone 70, the vessel 60, and the feeder 40, thus forms a system through which air flow moves the build material 20. The PCS 50 may not be an entirely closed system, some leakage can be tolerated. Leakage below the cyclone 70, however, can be problematic. For instance, if air velocity in the cyclone 70, flowing upward through the feeder 40, exceeds some rate, powder separation of the cyclone may be disturbed, and the separation efficiency of the cyclone may be lost. This principle is described in more detail below.

The feeder 40 is disposed below (or downstream of) the vessel 60. The feeder 40 opens to receive build material 20 from upstream and to dispense the build material further downstream. The cyclone 70, the vessel 60, and the feeder 40 are connected, and are also coupled to the PCS 50. This means that, when open, the feeder 40 may reduce the cyclone separation efficiency and thus compromise the efficiency of the PCS 50. Because the PCS 50 conveys build material by applying air pressure, the opening of the feeder 40 compromises the operation of the PCS.

In one implementation of the 3D printer 100, the mean air velocity in the build material-carrying conduits 66 of the PCS 50 is between 10 and 20 meters/second (m/sec). For example, for a build material such as polyamide 12 (PA12, a type of nylon), if the air flow velocity is less than 6 m/sec, the build material may settle in the horizontal conduit sections (see conduits 66B and 66D, for example).

Cyclonic separation may remove particles from air via vortex separation. A centrifugal separator, often known as a cyclone, performs this cyclonic separation to separate a received material into two portions, one of which is generally less dense than the other. Recall from FIG. 1C that the 3D printer 100 may include a centrifugal separator or cyclone 70 disposed above the vessel 60. Once the build material 20 is fed into the air stream of the PCS 50, the cyclone 70 is used to separate the build material from the conveying air before the build material is received into the vessel 60.

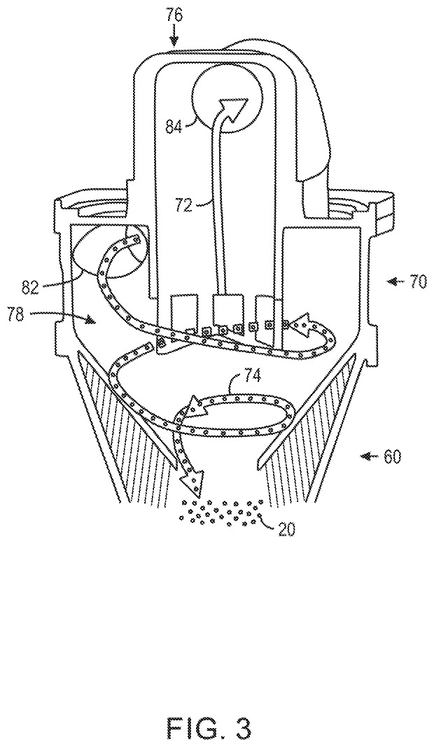

FIG. 3 is one example of a possible configuration of the centrifugal separator 70 and vessel 60 of the 3D printer 100. The centrifugal separator or cyclone 70 is disposed above the vessel 60 so that denser material, in this case, build material 20, is separated from the conveying air and received into the vessel 60.

The cyclone 70 is made up of an inner portion 76 and an outer portion 78. The air combined with the build material 20 coming from the PCS 50 is received into the PCS intake 82. The shape of the inner portion 76 creates a vortex in the middle of the cyclone 70 that causes the lighter air to flow upward (see air path arrow 72) while the heavier build material 20 flows downward and spreads centrifugally toward the walls of the separator (see build material path 74). This causes the build material 20 to drop into the vessel 60 while the air flows upward and out of the cyclone via the air outflow 84.

In one implementation, the 3D printer 100 has a single cyclone. In another implementation, multiple cyclones are disposed in parallel to one another in the 3D printer 100 to perform the separation operations described above. The efficiency of cyclone separation may be governed by the size of the build material particles, their density, the speed of the conveying air, geometrical factors, and static cling, to name a few factors.

In one implementation, the cyclone 70 of the 3D printer 100 is capable of separating 99.95% or more of build material in the 60-80 micron size range, 99.9% or more of build material in the 45-60 micron size range, and 99.5% of build material in the 10-20 micron size range. For build material smaller than 10 microns (known as fines), the cyclone 70 of the 3D printer 10 is designed to minimize or reduce the fines leaving the air outflow 84. Moreover, other separating percentages and associated particle size ranges are applicable.

Air leakage below the cyclone 70 can disturb cyclone efficiency by causing an updraft inside the cyclone. Such a leak may undesirably carry build material 20 through the air outflow 84 and back into the “clean” part of the PCS 50 (e.g., the output conveyance, 66E, 66F, 66G, and 66H in FIG. 2). The sealing control mechanism 30 of the novel feeder 40 in the 3D printer 100 is designed to prevent or reduce air leakage from entering the cyclone 70.

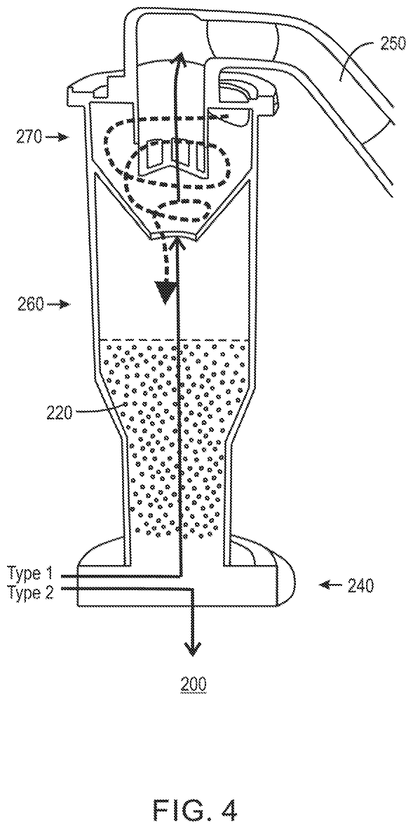

FIG. 4 is a diagram showing relative positions of components of a 3D printer 200 that may have a leakage problem. The 3D printer 200 includes a cyclone 270, a vessel 260, and a feeder 240. A downward spiraling arrow indicates the movement of build material 220 from the cyclone 270 into the vessel 260, with build material 220 indicating how full the vessel is. A PCS 250 transports build material 220 to the cyclone 270. An upward arrow indicates the flow of air back into the PCS 250, similar to the air flow of the cyclone 70 described in conjunction with FIG. 3, above. The feeder 240 is coupled to and below the vessel 260. External air may be pulled in as air leaks into the feeder 240, such as through gaps in the feeder 240 housing. Two possible leakages of air from the feeder 240 are indicated, a first leakage (type 1) with an arrow going upstream toward the cyclone 270, and a second leakage (type 2) with an arrow going downstream from the feeder 240.

The type 1 leakage of air sends the unwanted air from the feeder 240 upstream, such as with the leakage air having a differential pressure counter to the flow direction of the build material 220. This causes the unwanted air to move upward through the vessel 260. If the unwanted air leak makes its way into the cyclone 270 above the vessel 260, the separation efficiency of the cyclone may be compromised. As an example, if the unwanted air leak rate creates an air velocity through the cyclone cone of approximately 0.1 m/sec or more, cyclone separation efficiency is compromised. Thus, type 1 leakage is to be avoided because it can disturb powder flow through the cyclone 270.

The type 2 leakage of air sends unwanted air from the feeder 240 downstream. Again, air in the environment around or external to the feeder 240 may enter the feeder through gaps in the feeder housing. The unwanted air may move down through the feeder 240. This downstream transmission of the unwanted air may adversely impact the downstream conveyance and handling of build material.

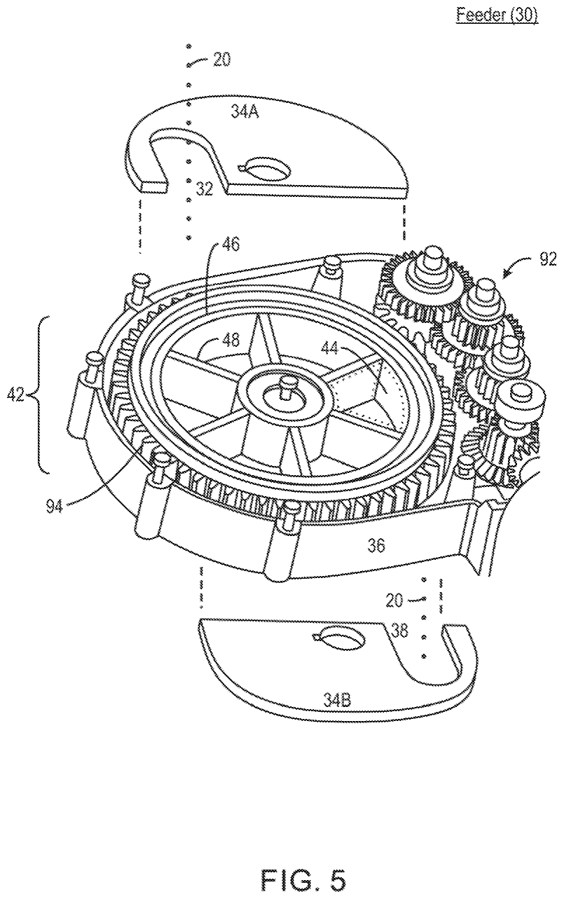

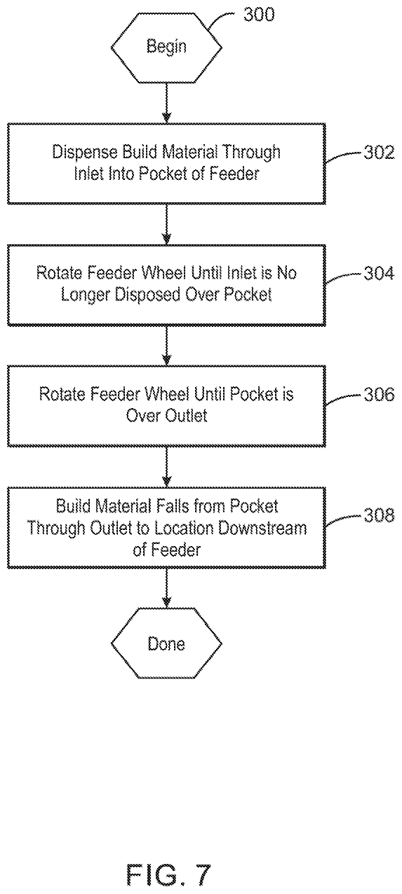

Thus, there are at least two distinct types of leakage that may impact the PCS 50 and other solids handling of the printer. A given feeder may deal with one of these types of leaks at a given moment. For cyclone efficiency, type 1 leakage is of concern. For downstream feeders such as feeders 440B, 440C, and 440D (FIG. 7, below), type 2 leakage may be a concern. A design to eliminate type 1 leakage does not necessarily eliminate type 2 leakage, and vice-versa. Both type 1 and type 2 leakage of unwanted air illustrated in FIG. 4 may be solved by the sealing control mechanism 30 of the feeder 40, as described in FIGS. 5 and 6, below.

Returning to FIG. 2, recall that the PCS 50 of the 3D printer 100 is a negative gauge pressure system. Whatever the PCS 50 is connected to is sealed off so that the negative pressure of the PCS operates effectively and efficiently. Thus, the other components of the PCS, such as the cyclone 70, the vessel 60, and the feeder 40, thus form a larger system that is impacted by the negative pressure. While a leak in some parts of the PCS 50 may be tolerated, a leak below the cyclone 70 is of particular concern, and may affect the cyclone's efficiency.

FIG. 5 is a detailed diagram of the feeder 40 of the 3D printer 100 to transfer build material 20 from an upstream location to a downstream one. The feeder 40 includes an upper shoe 34A, a lower shoe 34B (collectively, “shoes 34”), and a housing 46 that is sandwiched orthogonally between the shoes. Inside the housing 46, a chamber 42 is disposed below the upper shoe 34A and above the lower shoe 348. The chamber 42 is made up of a circular rim 46 and spokes or ribs 48, which form distinct pockets 44. The number of spokes 48 forming a like number of pockets 44 may vary. In one implementation, the chamber includes six spokes and six pockets of equal width. In a second implementation, the chamber includes at least three spokes and three pockets. In a third implementation, the number of pockets is great enough to give a smaller volume of each pocket such that air upflow velocity from an empty pockets is below a threshold (e.g., 0.1 m/sec) that would cause cyclone problems. In a fourth implementation, the volume of each feeder pockets 44 is between 4 and 10 cubic centimeters.

Surrounding the feeder 40 is a feeder wheel 94, which is adjacent to a gear train 92. The feeder wheel 94 has a number of teeth that may be engaged by adjacent teeth in the gear train 92. A gear train is a mechanical system formed by mounting gears in such a way that teeth of the gears engage with one another. In FIG. 6, the gear train has multiple gears (four in this example), which are strategically spaced to smoothly transition rotation from one gear to the next. As illustrated in FIG. 6, the gear train 92, which drives rotation of the feeder wheel 94, causing the feeder 40 to rotate, is controlled by the sealing control 30.

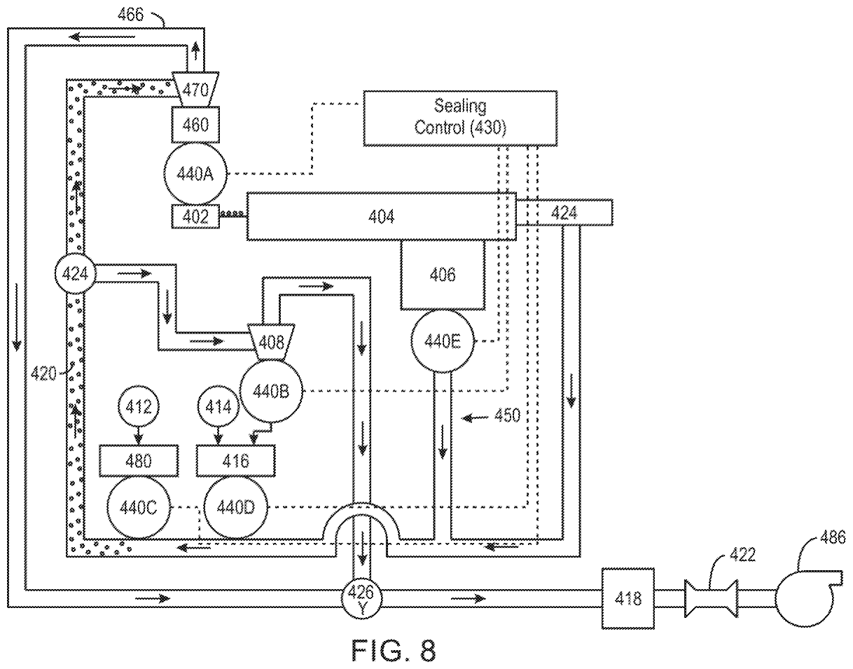

In one implementation, shown in FIG. 6, the sealing control mechanism 30 utilizes a DC motor 96, which is activated and controlled by an encoder 98. By digitally controlling the on and off states of the DC motor 96, the encoder 98 provides for control of the rotations per minute (RPM) of the feeder wheel 94 to be strictly controlled. Due to the gear train 92 between the feeder wheel 94 and the motor 96, the motor is run at faster speed than the desired RPM of the feeder wheel 94. In one example, the feeder wheel 94 is moved at between 2 and 20 RPM. In another example, the rotation of the feeder wheel 94 may operate continuously for a period before being turned off. Further, the sealing control mechanism 30 may control more than one feeder in the 3D printer 100. The operation of the sealing control mechanism 30 for multiple feeders is described in more detail below in FIG. 8, below.

An inlet (e.g., opening, slot, aperture, etc.) 32 is found in the upper shoe 34A while an outlet (e.g., opening, slot, aperture, etc.) 38 is found in the lower shoe 34B. The inlet 32 and outlet 38 may each be a hinged door, a size-varying aperture, a sliding slot, and so on. In one implementation, the inlet 32 and outlet 38 are typically open. In this example, the feeder 40 is cylindrical. In operation, the upper shoe 34A is sealed against the top surface of the rim 46 of the chamber while the lower shoe 34B is sealed against the bottom surface of the rim so that the chamber 42 and pockets 44 of the chamber are substantially sealed. Although the feeder 40 is depicted as being substantially cylindrical in shape, the feeder may be shapes other than as depicted in the illustration.

Build material 20 flows to the feeder 40 from an upstream location, such as a vessel, hopper, or build material supply. Through the inlet 32, a dollop (e.g., a volume or portion) of the build material 20 drops, by way of gravity, into one of the pockets 44 of the chamber 42, the one directly below the inlet 32. In one example, a dollop is about 5 grams. Each pocket 44 will generally contain something, either air, build material 20, or a combination of build material and air. Thus, the drop operation is an exchange. When the dollop of build material 20 drops into the designated pocket 44, the air inside the pocket is displaced upward out of the pocket.

Under control of the sealing control mechanism 30, the feeder 40 then moves rotationally such that the pocket 44 is no longer disposed directly below the inlet 32. For each rotation of the feeder 40 below the upper shoe 34A, the inlet 32 is disposed over an adjacent pocket 44. In one example, the width of the inlet is smaller than the width of each pocket. At this point, the pressure upstream of the feeder 40 is isolated from the pressure downstream of the feeder. Once the pocket 44 is disposed over the outlet 38, the dollop of build material drops (e.g., via aid of gravity) from the chamber 42 and moves downstream from the feeder 40. Again, the drop is an exchange in which, this time, the dollop of build material in the pocket 44 is replaced with air. Because air pressure in the pocket 44 is fluidically isolated from the upstream channels, particularly the cyclone 70, the incoming air generally will not travel upward and cause a problem. Instead, the sealing control 30 of the feeder 40 prevents or reduces backflow of air from the entry and exit points of the feeder mechanism, which, in turn, enables the negative pressure of the PCS 50 to move build material 20 within the conduits 66. In the example of FIG. 5, the inlet 32 and the outlet 38 are similarly shaped, but these openings may be dissimilar in shape and size. In another example, the chamber 42 is rotated at least twice between receiving build material 20 from the inlet 32 and depositing build material through the outlet 38. Put another way, there is at least one spoke-to-shoe seal, or sealing spoke, between the inlet 32 and the outlet 38 at any given position of the feeder 40; otherwise, there would be a direct leak path for the build material 20 to drop through the feeder.

Further, build material may become unintentionally disposed between the upper shoe 34A and the wail 46, between the wall and the lower shoe 348, and between other components making up the feeder 40. The volume of air leaking in these circumstances is generally small enough to not affect operation of the PCS. Thus, the escape of air from the feeder, whether upstream or downstream, may unintentionally occur.

In some examples, the sealing control mechanism 30 and encoder 98 may include or be associated with a computing device having a processor and memory storing code executed by the processor to adjust operation of the feeders. The computing device may be a controller. The controller may include a processor, microprocessor, central processing unit (CPU), memory storing code executed by the processor, an integrated circuit, a printed circuit board (PCB), a printer control card, a printed circuit assembly (PCA) or printed circuit board assembly (PCBA), an application-specific integrated circuit (ASIC), a programmable logic controller (PLC), a component of a distributed control system (DCS), a field-programmable gate array (FPGA), or other types of circuitry. Firmware may be employed. In some cases, firmware if employed may be code embedded on the controller such as programmed into, for example, read-only memory (ROM) or flash memory. Firmware may be instructions or logic for the controller hardware and may facilitate control, monitoring, data manipulation, and so on, by the controller.

FIG. 7 is a flow diagram illustrating the operations of the sealing control 30 in the feeder 40 of the 3D printer 100. The operation of the feeder 40 follows the conveyance of build material 20 from the PCS 50 to the cyclone 70, where the build material is separated from the conveying air. The build material 20 flows downstream to the vessel 60, where it is next received at the feeder 40. At this point, the operations of FIG. 7 commence.

A volume or dose of the build material 20 is dispensed through the inlet 42 located on the upper shoe 34A covering the chamber 42 of the feeder 40. where it is received into one of the pockets 44 (block 302). At this point, air inside the pocket 44 is displaced by the incoming build material 20 and flows upward through the inlet 32. By keeping the size of the pockets small, the 3D printer 100 manages the upward air flow without avoiding it entirely. In one example, the volume of air displaced in the pocket 44, though flowing upward toward the cyclone 70, is small enough to not negatively affect the cyclone performance. Put another way, the resultant air upflow rate would not exceed the threshold that causes a problem, such that powder downflow through the cyclone exit to the vessel would not be disturbed.

Next, the feeder wheel 94 is rotated so that the inlet 32 is no longer above the pocket containing build material (block 304). In one example, the upstream pressure is entirely isolated from the downstream pressure at this point. The feeder chamber wheel 94 is rotated again until the pocket 44 is disposed over the outlet 38 in the lower shoe 34B (block 306). In one example, the feeder wheel is turned at a revolution rate that is proportional to the g/sec transfer rate of the build material. Once so disposed, the volume or dose of build material 20 is dispensed from the pocket 44 through the outlet 38 and fed downstream (block 308). Thus, the operations of the sealing function 30 are complete.

FIG. 8 is a diagram of a 3D printer 400 implementing the sealer function 30 described in FIGS. 5 and 6 above. In the 3D printer 400, there are five feeders 440A, 440B, 440C, 440D, and 440E (collectively, “feeders 440”), one or more of which may benefit using the sealing control 30. In one implementation, the sealing control mechanism 30 controls all five feeders 440. In addition to the feeders 440 and sealing function 430, the PCS 450 includes conduits 466, an air intake or lung 424, a blower 486, and a filter 418 as before, but, in this example, also features a Venturi 422, located at the end of the output conveyance of the PCS, just before the blower 486. Recall that the output conveyance of the PCS should contain air, not build material. However, some build material may find its way in the output conveyance of the PCS. The filter 418 captures this errant build material. In one example, the filter 418 is accessible to a user of the 3D printer 400 and may be removed and replaced, such as following a recommended number of 3D print jobs. The venturi is a passive device used to measure a differential pressure used to discern the volumetric flow rate of air in the conduit 66.

Once the blower 486 is activated, a negative pressure vacuum sucks air from the lung 424, which sends air through the input conveyance of the PCS 450. The 3D printer 400 includes two hoppers or vessels containing build material 420, a build material vessel 480 and a recycle material vessel 416. Each of these include a feeder 440C and 440D, respectively, which dispense build material 420 to the conduits 466. The build material vessel 480 may include fresh or “new” build material while the recycle material vessel 416 contains recycled or “reclaimed” build material. The 3D printer 400 may accept new build material, recycled build material, or a combination of the two, into the PCS 450 for generating the next 3D object.

In one implementation, a build material cartridge 412 is connected to the build material vessel 480. The build material cartridge 412 may be removable by a user and replaced with a new cartridge. Similarly, a recycle material cartridge 414 is coupled to the recycle material vessel 416, allowing a user to remove and replace the cartridge as needed.

The cyclone 470 is connected downstream to a vessel or hopper 460, and the feeder 440A, which is controlled by the sealing control 430. The feeder 440A dispenses build material 420 to a powder handling system 402. The build material 420 is then dispensed to the build chamber 404. A 3D object is generated in the build bucket 406. A feeder 440E, also controlled by the sealing control mechanism 430, is disposed below the build bucket 406 to orderly transport unused build material downstream. Operations of the powder handling system 402, the build chamber 404, and the build bucket 406 are beyond the scope of this disclosure.

A PCS diverter valve 424 allows the build material 420 to be diverted to a second cyclone and vessel 408 coupled to a second feeder 440B. Like the feeder 440A, the feeder 440B may be controlled by the sealing control 430. The isolation of pressure obtained by the sealing control 430, prevents or reduces unwanted air from adversely impacting the efficiency of the cyclone 408, and from negatively impacting the flow of build material downstream. In an example, the build material 420 received into the feeder 440B flows either to the recycle material cartridge 414 or to the recycle material vessel 416.

In an example, the 3D printer 400 includes two additional feeders 440C and 440D, one to dispense fresh build material from the build material supply 480 and another to dispense recycle build material from the recycle material vessel 416. Both feeders 440C and 440D may be controlled by the sealing control 30, to ensure that pressure between upstream devices and the feeder are isolated and pressure between the feeder and the downstream PCS 450 is isolated.

Feeders 440A and 440B are disposed below cyclones 470 and 408. respectively. Both feeders will benefit from utilizing the sealing control mechanism 430, because the mechanism prevents type 1 leaks from impacting the operation of the respective cyclones. For feeders 440C, 440D, and 440E, the concern is to avoid type 2 leakage. The sealing mechanism 430 also will prevent type 2 leaks from adversely impacting the flow of powder downstream. The sealing control mechanism 430 is thus capable of mitigating the effects of both type 1 and type 2 leakages.

In an example, the sealing control 430 may establish continuous rotation of the lower feeders 440C and 440D for a time period (e.g., 25 seconds), then the lower feeders are stopped for a second time period (e.g., 10 seconds). The vessels of the 3D printer 400, such as the upper vessel 460, for example, may include a sensor that indicates how full the upper vessel is. This information may be used by the sealing control mechanism 430 to turn feeders on and off. This gives time for the PCS 50 to deliver powder to the upper feeders 440A and 440B. A feeder may be stopped because the receiving unit downstream of the feeder has received a sufficient supply of build material.

The above examples illustrate use of the feeder 40 and sealing control mechanism 30 in a 3D printer. The feeder 40 and sealing control 30 may also be used in a powder management station to maintain a desired flow of powder.

While the present techniques may be susceptible to various new modifications and alternative forms, the examples discussed above have been shown by way of example. It is to be understood that the technique is not intended to be limited to the particular examples disclosed herein. Indeed, the present techniques include alternatives, modifications, and equivalents falling within the true spirit and scope of the appended claims.

What is claimed is:

1. A three-dimensional (3D) printer comprising:
a pneumatic conveyance system (PCS) disposed internal to the 3D printer, the PCS to transport build material to a vessel, the PCS further comprising:
a feeder coupled to the vessel, the feeder to regulate discharge flow of the build material from the vessel; and
a sealing control coupled to the feeder, the sealing control to reduce air-inflow counter to a direction of build material transfer.

2. The 3D printer of claim 1, the feeder further comprising:
a chamber comprising a pocket, the pocket to receive a volume of build material from the vessel, wherein the pocket is moved so that pressure in the PCS and downstream of the feeder are isolated.

3. The 3D printer of claim 1, the feeder further comprising:
a rotatable chamber comprising a plurality of pockets
an upper shoe comprising an inlet, wherein the upper shoe is disposed atop the rotatable chamber; and
a lower shoe comprising an outlet, wherein the lower shoe is disposed below the rotatable chamber such that the chamber is sandwiched between the upper shoe and the lower shoe:
wherein a volume of build material is to be received through the inlet into a first pocket of the plurality of pockets.

4. The 3D printer of claim 3, wherein the rotatable chamber is rotated so that the first pocket is not disposed beneath the inlet and above the outlet simultaneously;
wherein at least one sealing spoke exists between the inlet and the outlet.

5. The 3D printer of claim 4, wherein the rotatable chamber is rotated so that the first pocket is disposed above the outlet;
wherein the volume of build material flows out of the feeder downstream.

6. The 3D printer of claim 1, the PCS further comprising:
a centrifugal separator disposed upstream of the vessel, the centrifugal separator to receive the build material from the PCS, separate the build material from conveying air, and discharge the separated build material to the vessel;
wherein resultant air upflow rate due to the feeder receiving the build material does not disrupt powder downflow through the centrifugal separator.

7. The 3D printer of claim 3, the sealing control further comprising:
a direct current (DC) motor to generate a motive force to a feeder wheel of the feeder.

8. The 3D printer of claim 7, the sealing control further comprising:
an encoder to control on and off states of the DC motor.

9. A method of operating a three-dimensional (3D) printer, comprising:
conveying, via a pneumatic conveyance system, build material to a vessel;
dispensing the build material from the vessel through an inlet of a feeder into a pocket of the feeder, the vessel being disposed above the feeder and the inlet being disposed above the pocket:
controlling a rotation of the feeder until the pocket is no longer below the inlet, the inlet at a first pressure, the outlet at a second pressure, wherein the first pressure is isolated from the second pressure; and
generating a 3D object from the build material, wherein the conveying is contemporaneous with the generating of a 3D object.

10. The method of claim 9, controlling a rotation of the feeder further comprising:
activating a direct current (DC) motor coupled to a feeder wheel, wherein the DC motor supplies a motive force to the feeder wheel, causing the feeder to rotate; and
enabling an encoder to digitally control an on state of the DC motor.

11. The method of claim 9, further comprising:
conveying the build material through a centrifugal separator to the vessel, the centrifugal separator to separate the build material from conveying air and discharge the separated build material to the vessel; and
rotating the feeder until the pocket is disposed above an outlet of the feeder, wherein the build material is dropped downstream from the feeder;
wherein air entering the pocket from downstream is isolated from the centrifugal separator, reducing movement of air counter to flow direction of build material from the vessel.

12. A feeder to be used by a three-dimensional (3D) system, the feeder comprising:
a chamber comprising a circular rim and spokes disposed inside and orthogonal to the rim, the rim and spokes to form pockets in the chamber, wherein rotation of the chamber is controlled by a direct current (DC) motor;
an upper shoe comprising an inlet; and
a lower shoe comprising an outlet, wherein the chamber is sandwiched between the upper shoe and the lower shoe;
wherein the feeder receives build material from an upstream location and deposits the build material to a downstream location as follows:
receives build material through the inlet into a pocket disposed directly below the inlet, the pocket being associated with a first air pressure;
rotates the feeder until the pocket is no longer below the inlet but is above the outlet;
deposit build material downstream through the outlet;
wherein the air pressure in a region upstream of the feeder is isolated from a second region downstream of the feeder, where both upstream and downstream refers to a direction of build material flow.

13. The feeder of claim 12, wherein the DC motor is turned on and off using an encoder.

14. The feeder of claim 12, further comprising:
a feeder wheel surrounding the chamber, the feeder wheel comprising teeth which, when moved, cause the feeder to rotate; wherein the feeder wheel is controlled by the DC motor.

15. The feeder of claim 12, wherein a pneumatic conveyance system transports the build material to a centrifugal separator and the build material is received in the pocket of the feeder and discharges the build material from the feeder to components of the 3D system, wherein both the pneumatic conveyance system and the centrifugal separator are operable during generation of a three-dimensional object by the printer.
